(19) United States
(12) Patent Application Publication
(10) Pub. No.: US 2025/0158658 A1
(43) Pub. Date: May 15, 2025

(54) SYSTEMS AND METHODS FOR OPTIMIZING SHORT-RANGE WIRELESS READ OF CONTACTLESS CARDS USING VIDEO SIGNAL

(71) Applicant: Capital One Services, LLC, McLean, VA (US)

(72) Inventors: Erik NEIGHBOUR, McLean, VA (US); Anatoly IVASYUK, Falls Church, VA (US); Christopher MATTHEWS, Arlington, VA (US)

(21) Appl. No.: 18/388,945

(22) Filed: Nov. 13, 2023

(51) Int. Cl. H04B 5/77; G01J 1/42; G01J 5/00; G01J 5/08; G06T 7/20; G06T 7/70; G06V 20/40

(52) U.S. Cl. CPC H04B 5/77; G01J 1/4204; G01J 5/0859; G06T 7/20; G06T 7/70; G06V 20/40; G01J 2005/0077; G06T 2207/10016; G06T 2207/10048; G06T 2207/30241

(57) ABSTRACT

The disclosed systems and methods are directed to optimizing short-range wireless read operation for performing a proximity-based reading of a contactless card by a NFC reading unit of a user device. The described implementation utilizes a video signal from a camera unit of the user device which is automatically activated upon detection of an NFC tag within a communication field of the reading unit. Various aspects of the video signal may be analyzed and processed for determination of the final position of the card on the user device, prior to performing a NFC read, following a card tap action by the user. The described implementation uses variations in signal attributes of the video feed to determine a trajectory of the card within the optical view field until the video signal goes dark or drops below a threshold.

### FIELD OF THE DISCLOSURE

The present disclosure is generally related to proximity-based wireless communication and more specifically to optimizing near-field communication (NFC) in contactless cards using sensor-based guidance.

### BACKGROUND

One important aspect of optimizing near-field communication with contactless cards, is based on a positional alignment provided between an NFC transceiver (e.g., an antenna and/or conductive coil integrated into a card chip) of the contactless card and the reading device. Establishing an optimal positional alignment for performing a wireless data transfer (e.g., via NFC read and/or write commands) may sometimes involve manual adjustments by the user to find the optimal position for wireless communication. However, these manual adjustments can be time-consuming and may not always result in the desired alignment.

These and other deficiencies exist. As such, there is a need for an improved system and process for accurate automation of the alignment process required for optimizing short-range wireless communication between a contactless card and a NFC reader unit of a user device.

### SUMMARY OF THE DISCLOSURE

In some aspects, the techniques described herein relate to a device for optimizing near-field communication with a contactless card, the device including: a processor; a memory storing one or more applications, the one or more applications including a wireless intermediary application; a plurality of sensors including one or more optical cameras; and a communication interface configured to create a communication field; wherein, upon entry of a contactless card within the communication field, the intermediary wireless application is configured to: activate the one or more optical cameras; process, a video signal from the one or more optical cameras to: identify the contactless card, based on detection of a rectangular form at a first position within a view field of the one or more optical cameras; determine, based on a light sensor output associated with the device, a light intensity value associated with the view field including the contactless card, compute a trajectory of the contactless card, based on one or more transitions in the light intensity value, as the contactless card moves within the view field of the one or more optical cameras; predict, upon detecting the light intensity value dropping below an intensity threshold, a second position of the contactless card based on the trajectory; initiate, upon determining that the second position of the contactless card corresponds to an optimal wireless alignment with the receiving device, a wireless scanning process; generate, upon determining that the second position of the contactless card does not corresponds to an optimal wireless alignment, one or more user notifications with respect to the optimal wireless alignment.

In some aspects, the techniques described herein relate to a method of optimizing near-field communications with a contactless card, the method including: activating one more optical cameras on a reader device upon detecting a contactless card within a near-field communication range of the reader device; identifying the contactless card, by detecting a rectangular form at a first position within a view field of the one or more optical cameras; determining, based on a light sensor output associated with the reader device, a light intensity value associated with the view field including the contactless card; computing a trajectory of the contactless card, based on one or more transitions in the light intensity value, as the contactless card moves within the view field of the first and the second optical sensors; predicting, upon detecting the light intensity value dropping below an intensity threshold value, a second position of the contactless card based on the trajectory; initiating, upon determining that the second position of the contactless card corresponds to an optimal wireless alignment with the receiving device, a wireless scanning process associated with the device; generating, upon determining that the second position of the contactless card does not corresponds to an optimal wireless alignment, one or more user notifications with respect to the optimal wireless alignment.

In some aspects, the techniques described herein relate to a non-transitory computer-accessible medium including instructions for execution by a computer hardware arrangement, wherein, upon execution of the instructions the computer hardware arrangement performs procedures including: activating one more optical cameras on a reader device upon detecting a contactless card within a near-field communication range of the reader device; identifying the contactless card, by detecting a rectangular form at a first position within a view field of the one or more optical cameras; determining, based on a light sensor output associated with the reader device, a light intensity value associated with the view field including the contactless card; computing a trajectory of the contactless card, based on one or more transitions in the light intensity value, as the contactless card moves within the view field of the first and the second optical sensors; predicting, upon detecting the light intensity value dropping below an intensity threshold value, a second position of the contactless card based on the trajectory; initiating, upon determining that the second position of the contactless card corresponds to an optimal wireless alignment with the receiving device, a wireless scanning process associated with the device; generating, upon determining that the second position of the contactless card does not corresponds to an optimal wireless alignment, one or more user notifications with respect to the optimal wireless alignment.

### BRIEF DESCRIPTION OF THE DRAWINGS

FIG. 1A and FIG. 1B illustrate proximity-based wireless connectivity for enabling NFC-enabled communication with a contactless card, in accordance to some embodiments of the present disclosure.

FIG. 2 is an example overview showing a video signal, from a camera unit, encoding a relative position of the card within the optical field of view (FOV) as a function of FOV obstruction, in accordance to some embodiments of the present disclosure.

FIG. 3 illustrates an operational overview for proximity-based activation of a mobile NFC application, using a camera feed signal for detection of an optimal card placement, in accordance to some embodiments of the present disclosure.

FIG. 4 illustrates an exemplary operational flow diagram for implementing card placement to maximize a probability of a successful NFC read, in accordance to some embodiments of the present disclosure.

FIG. 5 illustrates a block diagram of an exemplary system, in accordance with some embodiments of the present disclosure.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

A near-field communication (NFC) functionality, integrated into a user device, may be controlled by an NFC application programming interface (API) executing on a user device. (e.g., iPhone®). One aspect of the present disclosure is directed to a novel implementation of the NFC reading process for improving efficiency and resource utilization associated with such process. In particular, one aspect of the disclosed solution is based on increasing a probability of a successful NFC read. This may be achieved by automating a positional alignment process between an NFC tag on a contactless card (e.g., an antenna and/or conductive coil integrated into a card chip) and a NFC reader unit on of user device, prior to initializing an NFC application and/or application programming interface (API) for executive a wireless read and/or write of the contactless card.

Accordingly, one aspect of the present disclosure is directed to optimizing operation of an NFC reading API based on a triggering condition associated with an optimal placement of the contactless card, to thereby increase a probability of a successful exchange of NFC-transmittable data (e.g., NFC read and/or write of the contactless card). In some embodiments, a camera unit may be used for capturing consecutive images and/or a video of the contactless card as the card is tapped against a reader. The captured data may then be analyzed to determine a landing position and orientation of the contactless card during a tap-based read action which involves the card to be placed against the reading surface of the reader device (e.g., a user mobile device). Accordingly a positioning signal generated from the aforementioned arrangement may be utilized to trigger the NFC reading API executing on the mobile device and initiating a NFC read process, so as to increase the probability of a successful read.

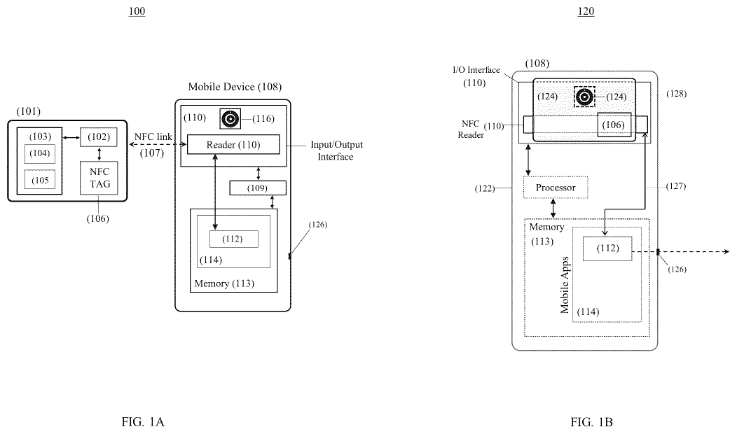

Example 100, illustrated in FIG. 1A, provides an exemplary representation of a contactless card 101 configured with an NFC interface/tag 106 and a user mobile device 108 configured with an NFC reader unit 110. The contactless card may comprise an integrated processor 102 and memory 103 that may store, for example, user identifying and/or authenticating information as near field communication (NFC) transmittable data (e.g., NFC Data Exchange Format (NDEF)). The integrated memory 103 may store one or more applets 104 that may be communicatively coupled to one or more applications running on the user mobile device 108 (e.g. NFC reading application and/or API 112 for facilitating one or more wireless reads of the contactless card 101). The card-integrated memory 103 may also store an application transaction counter 105 to keep track of a proper sequence of read operations associated with the contactless card. The contactless card 101 may further comprise a Near Field Communication (NFC) interface 106 to facilitate NFC communication with an NFC reader (e.g., reader unit 110 of the user mobile device 108 via NFC link 107.) A wireless read of the contactless card may be performed by the reader unit 110 of the mobile user device 108, by bringing the contactless card within an NFC range of the mobile device (e.g., by tapping the contactless card on a reader of the user mobile device). Example 120 of FIG. 1B illustrates a physical positioning of the contactless card 104, and in particular NFC interface 106 of the contactless card against the NFC reader unit 110 of the user device 108 for establishing an optimal NFC connectivity (e.g., corresponding to NFC link 107) Upon establishing an NFC link, in accordance to the overlapping positional arrangement 120 of the contactless card NFC tag 106 and the reader unit 110 of the mobile device 108, NFC reading application/API 112 may be activated to initiate a wireless read, via the reader unit 110. Therefore, in some embodiments, activation of the NFC reading application/API 112 is contingent upon establishment of NFC link 107, based on the exemplary card placement 120. As illustrated in FIG. 1B, the alignment of the contactless NFC tag 106 with the NFC reader element 110 of the user device may result in the camera unit 116 being covered by the contactless card 106. Therefore a video signal generated by the camera unit 116 may be used to guide the placement of the contactless card based at least on one known signal point corresponding to a reduction of light intensity within the view field of the camera unit 116 (e.g., video feed going dark as substantial amount of light may be blocked off by the body of the card when placed in an optimal NFC alignment with respect to a front-facing surface of the mobile device 108.) As shown in FIG. 1B, upon detection of an optimal NFC alignment 120, an activation signal 127 may be transmitted to the NFC reading application 112. In response to the activation signal 127, NFC API 112 may generate an NFC read command which is transmitted via the NFC reader unit 126 to the NFC tag of the contactless card 124.

Referring back to FIGS. 1A and 1B, the user device 108, may include one or more processors 109 (e.g., one or more microprocessors), coupled to memory 113, which may be, for example, random access memory (RAM), read-only memory (ROM), programmable read-only memory (PROM), erasable programmable read-only memory (EPROM), and/or electrically erasable programmable read-only memory (EEPROM), and the user device 108 may include one or more of these memories. Memory 113 may include one or more applications 114, for facilitating NFC-based exchange of data with an external source within an NFC field of the mobile device. Accordingly the mobile device 108 may be configured for wireless communication with the contactless card 104 via a short-range wireless connection (e.g., NFC), and network communication, via a network interface 126 with one or more remote servers. The user mobile/computing device 108 may include a processor 109, a memory 113, and one or more applications 112. The processor 109 may be a processor, a microprocessor, or other processor, and the user device 108 may include one or more of these processors. The processor 109 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

As described above, the user device 108 may include a read-only memory 113. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 113 may be configured to store one or more software applications, such as applications 114, and other data, such as user's private data and financial account information. Applications 114 may comprise for example, a NFC reading application and/or API 112 and one or more banking and/or data collection applications with one or more Application Programming Interface (API) components. User (mobile) device 108 may further include one or more Input/Output (I/O) devices 128 for capturing user inputs and displaying one or more information records and/or notification messages to the user. For example, I/O devices 128 may include at least one display and input device. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user (mobile) device that is available and supported by the device, such as a touch-screen, keyboard, mouse, cursor-control device, touch-screen, microphone, digital camera, video recorder or camcorder. As shown in FIGS. 1A and 1B, I/O devices 128 of user device 128 may also include a camera unit 124. The I/O devices may be used to enter information and interact with the contactless card as described herein.

I/O devices 219, associated with the user device 122, may further include an electronic reader unit 126 for capturing information via one or more short range communications protocols such as Near Field Communication (NFC). The user device 108 may be configured to transmit one or more read instructions to the contactless card 101, via NFC link 107. The user device 108 may be a network-enabled computer device, with a network communication interface 126. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other network-enabled computing or communications devices. For example, network-enabled computing devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. It is further understood that the user (mobile) device may be of any type of device that supports the communication and display of data and user input. The present disclosure is not limited to a specific number of user devices, and it is understood that the system 300 may include a single client device or multiple client devices.

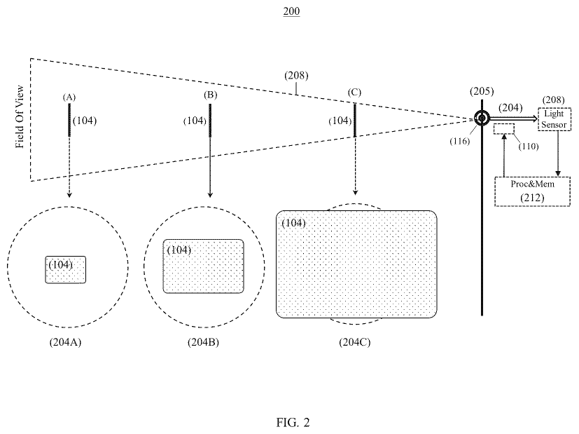

In accordance to one aspect of the present disclosure, the a signal source for tracking a trajectory of a card within a communication field (e.g., for maximum proximity-based communication) may involve a front facing camera 116 and the video signal feed 204 sourced therefrom. The illustrated example 200 shows a side view 205 of the user device 108. Information regarding a trajectory of the card within the optical FOV 208 of the camera unit 116 may be encoded into the video feed signal 204. Position points A, B and C correspond to varying positions of the contactless card 104 (illustrated as a side-view representation) as it moves through the optical FOV 208. Exemplary front-view representations of the optical FOV 208 at position points A, B and C are represented by 204A, 204B, 204C, in example 200 illustrated in FIG. 2. The exemplary FOV representations 204A, 204B, 204C correspond to the relative area of the optical FOV 208 covered by the contactless card 104 (e.g., relative size of the contactless card image within the FOV) at each position point A, B and C along a trajectory towards the reading surface of the mobile device 205 (e.g., an NFC reader element 110 disposed in proximity to camera unit 116).

Information regarding a trajectory of the card within the optical FOV 208 of the camera unit 116 may be encoded into the video feed signal 204. The encoded information may correspond to a variety of data points associated with varying positions of the contactless card 104 as it moves through the optical FOV 208, and may be used to compute a trajectory of the card and project a final placement against a reader unit 112 during a tap action (being executed a user). Various aspects of the video signal may be analyzed for determination of the final position of the card on the user device during a NFC read, executed via a tap action. In one example, changes in an intensity value of the video signal (e.g., light captured within the view field of the camera unit 116) may be used as a measure of distance away from the reader unit of the user device. For example, the FOV representations 204A-204C may be associated with different intensity measurements as a function of relative area obstructed by the contactless card at various points along its trajectory toward the reader unit 110. Taking the aforementioned output intensity readings as an NFC activation signature, a signal may be transmitted to and processed by the integrated processing and memory elements 212 of the reader device to identify the aforementioned NFC activation signature, to trigger the operation of the NFC reading API and perform the NFC read of the contactless car 104 with the NFC reader unit 110. The described proximity-based triggering scheme is associated with an increase in the likelihood of a successful read of the contactless card 104 by the reader unit 110 of the mobile communication device 108.

In some embodiments, video feed 204, associated with the optical FOV 208, may be processed for average intensity values associated with various crossing points (e.g., A, B, C). As described above, the processing may be performed by an integrated processing and memory elements 212. The NFC data transfer command may then be transmitted to the NFC reader element of the mobile device. If the final placement, as indicated by an intensity measurement of the video signal 204, corresponds to placement position shown in example 120 of FIG. 1B, an NFC Read and/or write operation may be carried out by the reader unit 110. In some embodiments, the camera unit 116 may be automatically activated by the integrated processing unit 212, upon detection of an NFC tag within a communication field generated by the user device 108.

Another exemplary implementation may use information regarding a degree of image resolution and/or focus as an indicator of proximity and projection of landing point, for the contactless card, against the NFC reader unit 110. In exemplary embodiment 200, position A may correspond to a card to camera distance (i.e. distance between the object and the camera lens) at which a rectangular form of the card is first detected and recognized by the video signal processing unit 212. Position point B may correspond to the working distance (WD) where the captured card image is at its sharpest focus. Position point C may correspond to a maximum range where the card image appears to be in acceptable focus (e.g., representing a depth of field (DoF) of the camera). In some embodiments, position point A may correspond to the working distance at which the card image is in full focus, position point B may correspond to the depth of field distance at which the image is out of focus, and position point C may correspond to the distance at a which the video feed goes dark (e.g., camera aperture being substantially covered by the contactless card.) By detecting one or more video signal attributes corresponding to the varying position of the contactless card within the optical FOV of the camera unit, a determination can be made as to the final landing position of the contactless card against a reading surface of the mobile device 108.

As a landing position of the contactless card may depend upon varying paths to the reading surface, analysis of the video signal may further encode any deviations in the trajectory of the card. The trajectory information may be stored and analyzed by the integrated processing and memory element 212 to compute trajectories most likely associated with successful NFC reads of the contactless card, based on recorded data during each NFC read attempt performed by a user. In some embodiments a mathematical function may be fitted to the data for determination of optimal paths (e.g., paths resulting in a landing position against the reading surface of the mobile device which corresponds to an optimal NFC proximity between the card's NFC tag and the NFC reader unit).

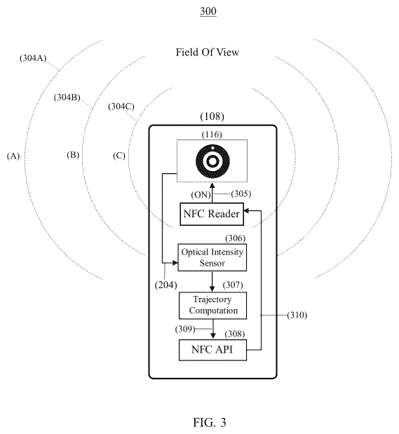

FIG. 3 illustrates an exemplary processing arrangement for computing a placement of the contactless card based on the video signal 204 generated by the camera unit 116. The NFC scanning process may be automatically enabled upon activating a user communication device (e.g., responsive to unlocking of the screen). Once the NFC scanning process is initiated, a detection of a NFC tag within the NFC field of the user device, may trigger the front camera unit 116 to be switched on, as shown by the camera ON signal 305. A video signal 204 generated by the front camera unit 116 of the user device 108 may then be used for tracking a trajectory of the contactless card. In some embodiments, the position of the card may be tracked with respect to a narrowing FOV 304A 304B and 304C corresponding to card positions A, B and C, respectively. FOV representation 304A-304C correspond to an approximate representation of the relative two dimensional area of the optical FOV encompassing the contactless card along various approach points, corresponding to card position at points A, B and C.

Video signal measurements corresponding to optical FOV (304A-304C) at card positions A, B and C respectively, may be fed into an optical intensity sensor and/or light sensor 306. Other attribute computed, from the video signal 204, based on movement of the card within the optical FOV of the camera unit may correspond to relative dimensions of the card's image with respect to the shrinking cross-section of the FOV (e.g., as illustrated by relative FOV representations 304A-304C) as the card moves towards the NFC reading unit disposed in proximity to the camera unit 116. The measurements corresponding to various video signal attributes measured by the light sensor 306, may then be fed into a trajectory computing process/module 307. The trajectory computation process/module 307 may process various video signal attributes (e.g., card image dimensions, image resolution/focus and/or optical intensity measurements) as an indicator of trajectory, to determine a placement of the contactless NFC tag against the NFC reader unit of the user device 108, when the video feed goes dark. Based on trajectory computations culminating in a drop in video signal intensity below a threshold value (as an indicator that the camera unit is fully covered by the contactless card) a predicted final placement of the card upon the reading surface of the user device may be determined. Once optimal placement for establishing a proximity-based NFC link is determined, the NFC reading API 308, stored on the user device 108, may be activated (e.g., communication path 309) to facilitate the NFC read and/or write operation, via the NFC reader unit of the user device, of the contactless card, as illustrated by communication path 310.

In some embodiments, camera unit 116 may be turned on based on detection of user activities that have been correlated with contactless reading of the card, based on historical data archived by the mobile device 108. Furthermore, previously recorded user behavior data associated with NFC read of the contactless card may be analyzed, using machine learning, to enhance the process for automating activation of the front-facing camera and improving prediction of a final placement. In some embodiments, previously tracked movements of the card within the optical view field that have resulted in successful, unsuccessful, and/or interrupted reads of the contactless card may be stored and used for determining an optimal placement based on a computed trajectory. In some embodiments, a misalignment of the card's NFC tag and the reader unit of the mobile device may trigger one or more user feedback notifications for correcting a placement of the card. The user feedback data may comprise visual and/or audio instructions to guide the user in correcting NFC alignment between the contactless card and a reading surface of the mobile device.

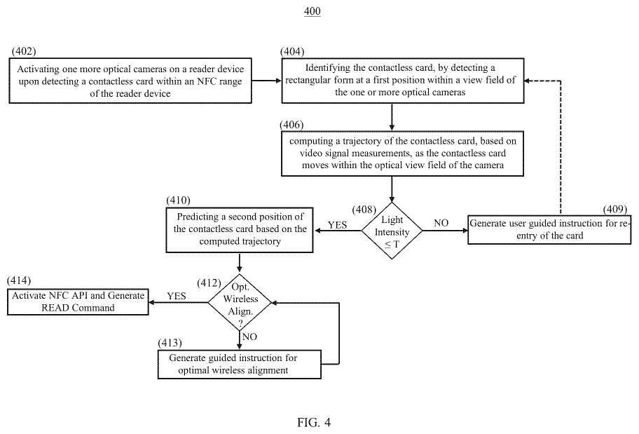

FIG. 4 illustrates an exemplary operation flow diagram 400 for implementing optimal proximity-based placement, for maximizing NFC connectivity between a contactless card and a reader unit of a user device, using a video signal feed from an integrated camera unit. The exemplary process is operative to trigger an NFC data transfer upon determining an optimal alignment between the NFC tag of the contactless card and the NFC reader of the user device. The video signal is used to facilitate a card placement conducive to optimal proximity-based communication of NFC data. As shown by the process flow 400, step 402 of the process corresponds to activation of one more optical cameras on the user device upon detecting a contactless card within an NFC range of the user device (e.g., the user device serving as a NFC reader.) Upon activation of the camera unit, the process may move to step 404 for identifying the contactless card, by detecting a rectangular form at a first position within a view field of the one or more optical cameras. Based a successful identification of the rectangular form associated with the contactless card, at step 404, the process moves to step 406 for computing a trajectory of the contactless card based on one or more light sensor output values (e.g., the light sensor associated with the camera unit) measured at various positions, as the contactless card is moved within the optical FOV of the camera (e.g., during a tap action) towards a NFC reading surface of the user device. In some embodiments, the light sensor output values may correspond to various transitions in the light intensity value, as the contactless card moves within the optical view field of the camera. In some embodiments, the light sensor output values may correspond to variation in one or more dimensions of the card image and/or image resolution/focus as the card moves, within the optical view field of the camera, towards a NFC reading surface of the user device.

At step 408, the process may determine whether light intensity value (e.g., light sensor output value) has dropped below a threshold intensity value T (e.g., video feed has gone dark). If the light intensity value is above the threshold value T, user guidance instructions may be generated at step 409. The user guided information may prompt for a re-entry of the card into the optical FOV of the camera unit, such that a final landing placement of the card covers the camera unit. In some embodiments the user guidance instructions 409 may require a user to re-try the tapping action in which case the process may re-execute steps 404 and 406, until a light intensity measurement at step 408 is determined to be below threshold level T.

Upon determining a below-threshold intensity value at step 408, the process may move to step 410 for predicting a second position (e.g., projected landing position/placement) for the contactless card based on the trajectory computations performed at step 406. If the second position of the contactless card, based on projected placement corresponds to an optimal NFC alignment, the process may move to step 414 for activating an NFC API resulting in generation and transmission of one or more NFC read and/or write commands, via the reader unit of the user device, to the contactless card. If at step 412 an optimal wireless alignment is not achieved, user guidance instruction may be generated, at step 413, to prompt the user to adjust a positioning of the contactless until an optimal alignment for performing an NFC read and/or write of the contactless card is detected, at which point the NFC reading API is activated as described with respect to step 414.

In some embodiment feedback instruction for providing card placement guidance may correspond to auditory signal directing the user to move the card with respect to the reading surface of the reader device.

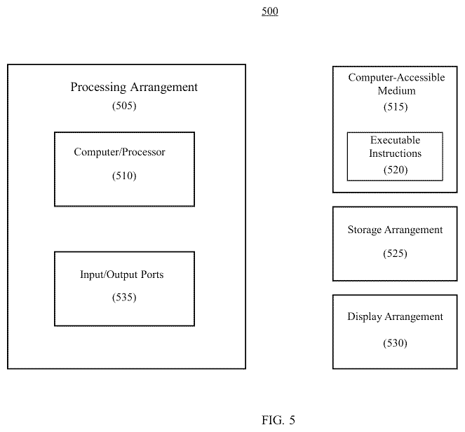

FIG. 5 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 505 may be configured for computing a trajectory of the contactless within an optical FOV generated by a camera unit of user device and projecting a final placement of the contactless against a reader unit of the user device at a point at which the camera feed goes dark). Such processing and/or computing arrangement 505 can be, for example entirely or a part of, or include, but not limited to, a computer and/or processor 510 that can include, for example one or more microprocessors, and use instructions stored on a computer-accessible medium (e.g., RAM, ROM, hard drive, or other storage device).

As shown in FIG. 5, for example a computer-accessible medium 515 (e.g., as described herein above, a storage device such as a hard disk, floppy disk, memory stick, CD-ROM, RAM, ROM, etc., or a collection thereof) can be provided (e.g., in communication with the processing arrangement 505). The computer-accessible medium 515 can contain executable instructions 520 thereon. In addition or alternatively, a storage arrangement 525 can be provided separately from the computer-accessible medium 515, which can provide the instructions to the processing arrangement 505 so as to configure the processing arrangement to execute the exemplary procedures, processes, and methods, as described herein above, for example.

Further, the exemplary processing arrangement 505 can be provided with or include an input and/or output ports 535, which can include, for example a wired network, a wireless network, the internet, an intranet, a data collection probe, a sensor, etc. As shown in FIG. 5, the exemplary processing arrangement 505 can be in communication with an exemplary display arrangement 530, which, according to certain exemplary embodiments of the present disclosure, can be a touch-screen configured for inputting information to the processing arrangement in addition to outputting information from the processing arrangement, for example. Further, the exemplary display arrangement 530 and/or a storage arrangement 525 can be used to display and/or store data in a user-accessible format and/or user-readable format.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

Systems and methods described herein can provide a system and configuration for performing an optimal NFC read of a contactless card by a reader device. Once a NFC link is established the wireless connectivity between the contactless card and the reader can permit, without limitation, financial transactions (e.g., credit card and debit card transactions), account management transactions (e.g., card refresh, card replacement, and new card addition transactions), membership transactions (e.g., joining and departing transactions), point of access transactions (e.g., building access and secure storage access transactions), transportation transactions (e.g., ticketing and boarding transactions), and other transactions.

In some aspects, the techniques described herein relate to a device for optimizing near-field communication with a contactless card, the device including: a processor; a memory storing one or more applications, the one or more applications including a wireless intermediary application; a plurality of sensors including one or more optical cameras; and a communication interface configured to create a communication field; wherein, upon entry of a contactless card within the communication field, the intermediary wireless application is configured to: activate the one or more optical cameras; process, a video signal from the one or more optical cameras to: identify the contactless card, based on detection of a rectangular form at a first position within a view field of the one or more optical cameras; determine, based on a light sensor output associated with the device, a light intensity value associated with the view field including the contactless card, compute a trajectory of the contactless card, based on one or more transitions in the light intensity value, as the contactless card moves within the view field of the one or more optical cameras; predict, upon detecting the light intensity value dropping below an intensity threshold, a second position of the contactless card based on the trajectory; initiate, upon determining that the second position of the contactless card corresponds to an optimal wireless alignment with the receiving device, a wireless scanning process; generate, upon determining that the second position of the contactless card does not corresponds to an optimal wireless alignment, one or more user notifications with respect to the optimal wireless alignment.

In some aspects, the techniques described herein relate to a device, wherein the trajectory of the contactless card is computed using a relative size of the rectangular form within a viewing frame associated with the viewing field.

In some aspects, the techniques described herein relate to a device, wherein the trajectory of the contactless card is computed stereoscopically using at least two distinct optical sensors on the device.

In some aspects, the techniques described herein relate to a device, wherein the plurality of sensors include one or more infrared cameras, and wherein the trajectory of the contactless card is computed using the one or more infrared cameras.

In some aspects, the techniques described herein relate to a device, wherein the first position corresponds to first instance of the detection of the rectangular form associated with the contactless card, in the view field of the one or more optical cameras.

In some aspects, the techniques described herein relate to a device, wherein the optimal wireless alignment corresponds to a positioning of the contactless card relative to the device for maximizing a possibility of a successful wireless read of the contactless card by the device.

In some aspects, the techniques described herein relate to a device, wherein the intensity threshold corresponds to a predetermined number for the average pixel value associated with the view field of the one or more optical cameras.

In some aspects, the techniques described herein relate to a device, wherein the one or more transitions in the light intensity values are used to identify an out of focus attribute of an image of the contactless card as an indicator of proximity as the contactless card moves within the view field.

In some aspects, the techniques described herein relate to a device, wherein a prediction of the second position for initiating the wireless scanning process, is initiated by a sequence corresponding to a detection of the rectangular form, followed by an identification of the out of focus attribute, followed by the light sensor output value dropping below the intensity threshold.

In some aspects, the techniques described herein relate to a device, wherein the one or more user notifications corresponds to one or more auditory signals for providing alignment instructions.

In some aspects, the techniques described herein relate to a device, wherein a machine learning model is used to identify an in-correct placements of the contactless card relative to the device, based on a predicted pattern in a user's card usage behavior.

In some aspects, the techniques described herein relate to a device, wherein the machine learning model is trained using historical training data corresponding to previous sequences of operations associated with previous contactless card transactions.

In some aspects, the techniques described herein relate to a device, wherein the machine learning model is used to determine the in-correct placement of the contactless card relative to the device, in absence of the detection of the contactless card by the one or more optical cameras.

In some aspects, the techniques described herein relate to a device, wherein the device includes a mobile communication device.

In some aspects, the techniques described herein relate to a method of optimizing near-field communications with a contactless card, the method including: activating one more optical cameras on a reader device upon detecting a contactless card within a near-field communication range of the reader device; identifying the contactless card, by detecting a rectangular form at a first position within a view field of the one or more optical cameras; determining, based on a light sensor output associated with the reader device, a light intensity value associated with the view field including the contactless card; computing a trajectory of the contactless card, based on one or more transitions in the light intensity value, as the contactless card moves within the view field of the first and the second optical sensors; predicting, upon detecting the light intensity value dropping below an intensity threshold value, a second position of the contactless card based on the trajectory; initiating, upon determining that the second position of the contactless card corresponds to an optimal wireless alignment with the receiving device, a wireless scanning process associated with the device; generating, upon determining that the second position of the contactless card does not corresponds to an optimal wireless alignment, one or more user notifications with respect to the optimal wireless alignment.

In some aspects, the techniques described herein relate to a method, wherein the trajectory of the contactless card is computed using a relative size of the rectangular form within a viewing frame associated with the viewing field.

In some aspects, the techniques described herein relate to a method, wherein the trajectory of the contactless card is computed stereoscopically using two distinct optical sensors on the reader device.

In some aspects, the techniques described herein relate to a method, wherein the first position corresponds to the first instance of detection of the rectangular form associated with the contactless card.

In some aspects, the techniques described herein relate to a method, wherein the optimal wireless alignment corresponds to a positioning of the contactless card relative to the reader device for maximizing a possibility of a successful wireless read of the contactless card by the reader device.

In some aspects, the techniques described herein relate to a non-transitory computer-accessible medium including instructions for execution by a computer hardware arrangement, wherein, upon execution of the instructions the computer hardware arrangement performs procedures including: activating one more optical cameras on a reader device upon detecting a contactless card within a near-field communication range of the reader device; identifying the contactless card, by detecting a rectangular form at a first position within a view field of the one or more optical cameras; determining, based on a light sensor output associated with the reader device, a light intensity value associated with the view field including the contactless card; computing a trajectory of the contactless card, based on one or more transitions in the light intensity value, as the contactless card moves within the view field of the first and the second optical sensors; predicting, upon detecting the light intensity value dropping below an intensity threshold value, a second position of the contactless card based on the trajectory; initiating, upon determining that the second position of the contactless card corresponds to an optimal wireless alignment with the receiving device, a wireless scanning process associated with the device; generating, upon determining that the second position of the contactless card does not corresponds to an optimal wireless alignment, one or more user notifications with respect to the optimal wireless alignment.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A device for optimizing near-field communication with a contactless card, the device comprising:
a processor;
a memory storing one or more applications, the one or more applications comprising a wireless intermediary application;
a plurality of sensors comprising one or more optical cameras; and
a communication interface configured to create a communication field;
wherein, upon entry of a contactless card within the communication field, the intermediary wireless application is configured to:
activate the one or more optical cameras;
process, a video signal from the one or more optical cameras to:
identify the contactless card based on detection of a rectangular form, at a first position, within a view field of the one or more optical cameras;
determine, based on a light sensor output associated with the device, a light intensity value associated with the view field comprising the contactless card;
compute a trajectory of the contactless card, based on one or more transitions in the light intensity value, as the contactless card moves within the view field of the one or more optical cameras; and
predict, upon detecting the light intensity value dropping below an intensity threshold, a second position of the contactless card based on the trajectory;
initiate, upon determining that the second position of the contactless card corresponds to an optimal wireless alignment with the device, a wireless scanning process; and
generate, upon determining that the second position of the contactless card does not corresponds to an optimal wireless alignment, one or more user notifications with respect to the optimal wireless alignment.

2. The device of claim 1, wherein the trajectory of the contactless card is computed using a relative size of the rectangular form within a viewing frame associated with the viewing field.

3. The device of claim 1, wherein the trajectory of the contactless card is computed stereoscopically using at least two distinct optical sensors on the device.

4. The device of claim 1, wherein the plurality of sensors comprise one or more infrared cameras, and wherein the trajectory of the contactless card is computed using the one or more infrared cameras.

5. The device of claim 1, wherein the first position corresponds to a first instance of the detection of the rectangular form associated with the contactless card, in the view field of the one or more optical cameras.

6. The device of claim 1, wherein the optimal wireless alignment corresponds to a positioning of the contactless card relative to the device for maximizing a possibility of a successful wireless read of the contactless card by the device.

7. The device of claim 1, wherein the intensity threshold corresponds to a predetermined number for an average pixel value associated with the view field of the one or more optical cameras.

8. The device of claim 1, wherein the one or more transitions in the light intensity values are used to identify an out of focus attribute of an image of the contactless card as an indicator of proximity as the contactless card moves within the view field.

9. The device of claim 8, wherein a prediction of the second position for initiating the wireless scanning process, is initiated by a sequence corresponding to a detection of the rectangular form, followed by an identification of the out of focus attribute, followed by the light sensor output value dropping below the intensity threshold.

10. The device of claim 1, wherein the one or more user notifications corresponds to one or more auditory signals for providing alignment instructions.

11. The device of claim 1, wherein a machine learning model is used to identify an in-correct placements of the contactless card relative to the device, based on a predicted pattern in a user's card usage behavior.

12. The device of claim 11, wherein the machine learning model is trained using historical training data corresponding to previous sequences of operations associated with previous contactless card transactions.

13. The device of claim 11, wherein the machine learning model is used to determine the in-correct placement of the contactless card relative to the device, in absence of the detection of the contactless card by the one or more optical cameras.

14. The device of claim 1, wherein the device comprises a mobile communication device.

15. A method of optimizing near-field communications with a contactless card, the method comprising:
activating one more optical cameras on a reader device upon detecting a contactless card within a near-field communication range of the reader device;
identifying the contactless card, by detecting a rectangular form, at a first position within a view field of the one or more optical cameras;
determining, based on a light sensor output associated with the reader device, a light intensity value associated with the view field comprising the contactless card;
computing a trajectory of the contactless card, based on one or more transitions in the light intensity value, as the contactless card moves within the view field of the one or more optical cameras;
predicting, upon detecting the light intensity value dropping below an intensity threshold value, a second position of the contactless card based on the trajectory;
initiating, upon determining that the second position of the contactless card corresponds to an optimal wireless alignment with the reader device, a wireless scanning process associated with the device; and
generating, upon determining that the second position of the contactless card does not corresponds to an optimal wireless alignment, one or more user notifications with respect to the optimal wireless alignment.

16. The method of claim 15, wherein the trajectory of the contactless card is computed using a relative size of the rectangular form within a viewing frame associated with the viewing field.

17. The method of claim 15, wherein the trajectory of the contactless card is computed stereoscopically using two distinct optical sensors on the reader device.

18. The method of claim 15, wherein the first position corresponds to a first instance of detection of the rectangular form associated with the contactless card.

19. The method of claim 15, wherein the optimal wireless alignment corresponds to a positioning of the contactless card relative to the reader device for maximizing a possibility of a successful wireless read of the contactless card by the reader device.

20. A non-transitory computer-accessible medium comprising instructions for execution by a computer hardware arrangement, wherein, upon execution of the instructions the computer hardware arrangement performs procedures comprising:
activating one more optical cameras on a reader device upon detecting a contactless card within a near-field communication range of the reader device;
identifying the contactless card, by detecting a rectangular form, at a first position within a view field of the one or more optical cameras;
determining, based on a light sensor output associated with the reader device, a light intensity value associated with the view field comprising the contactless card;
computing a trajectory of the contactless card, based on one or more transitions in the light intensity value, as the contactless card moves within the view field of the one or more optical cameras;
predicting, upon detecting the light intensity value dropping below an intensity threshold value, a second position of the contactless card based on the trajectory;
initiating, upon determining that the second position of the contactless card corresponds to an optimal wireless alignment with the reader device, a wireless scanning process associated with the device; and
generating, upon determining that the second position of the contactless card does not corresponds to an optimal wireless alignment, one or more user notifications with respect to the optimal wireless alignment.
